(19) United States
(12) Patent Application Publication
(10) Pub. No.: US 2025/0102980 A1
(43) Pub. Date: Mar. 27, 2025

(54) IMAGE FORMING APPARATUS

(71) Applicant: FUJIFILM Business Innovation Corp., Tokyo (JP)

(72) Inventors: Takuma ISHIHARA, Kanagawa (JP); Takashi Matsubara, Kanagawa (JP); Takashi Ohashi, Kanagawa (JP); Hina Saito, Kanagawa (JP); Sodai Higuchi, Kanagawa (JP)

(73) Assignee: FUJIFILM Business Innovation Corp., Tokyo (JP)

(21) Appl. No.: 18/585,665

(22) Filed: Feb. 23, 2024

(30) Foreign Application Priority Data
Sep. 27, 2023 (JP) 2023-164228

(51) Int. Cl. G03G 15/00; G03G 15/20

(52) U.S. Cl. CPC G03G 15/50; G03G 15/2064; G03G 2215/2038

(57) ABSTRACT

An image forming apparatus includes: an image forming unit that forms an unfixed image on a sheet; and a fixing device that fixes the unfixed image on the sheet, the fixing device including a fixing belt, multiple holding members that hold the fixing belt so as to allow the fixing belt to run, a pressing roller that presses the fixing belt from an outer circumferential surface side against one of the holding members to form a fixing processing part, a heater that heats the fixing belt, and a load adjustment mechanism that adjusts a load applied to the pressing roller and applies a fixing load to the pressing roller during a fixing operation. At least at the end of the fixing operation of the fixing device, the load adjustment mechanism applies, as necessary, a low load that is lower than the fixing load to the pressing roller.

### CROSS-REFERENCE TO RELATED APPLICATIONS

This application is based on and claims priority under 35 USC 119 from Japanese Patent Application No. 2023-164228 filed Sep. 27, 2023.

### BACKGROUND

### (i) Technical Field

The present disclosure relates to an image forming apparatus.

### (ii) Related Art

Japanese Unexamined Patent Application Publication No. 2007-3998 (claims 1 to 4, FIGS. 1 to 4) discloses an image forming apparatus including a fixing device that fixes, at a nip part between two rollers at least one of which is heated by a heat source, a toner image on a sheet passing through the center of the nip part.

The fixing device disclosed therein includes a first temperature detector that detects the temperature of a substantially central part of a transportable area of the two rollers in the width direction, and a second temperature detector that detects the temperature of a part outside a sheet passing area of the transportable area. The state of heating by the heat source is controlled based on the difference between the temperatures detected by the two temperature detectors.

Furthermore, in the fixing device disclosed therein, when the difference between the detected temperatures exceeds a preset temperature difference, the device transitions to standby and stops the supply of power to a heater, which serves as the heat source. Then, the two rollers are rotated until the temperature difference drops to the preset value.

Japanese Unexamined Patent Application Publication No. 2014-178509 (Claim 1, FIGS. 1 to 3) discloses an image forming apparatus including a fixing device that has: a heating rotary member; a pressure rotary member; a heat source for heating the heating rotary member; a cooling mechanism for cooling the pressure rotary member; a pressure application/removal mechanism for bringing the heating rotary member and the pressure rotary member into contact with or away from each other; a first temperature detector that detects the temperature of the central area of the heating rotary member in the axial direction; a second temperature detector that detects the temperature of an end area of the pressure rotary member in the axial direction; and a controller that controls the power supply to the heat source and the cooling mechanism.

In the fixing device disclosed therein, assuming that the temperature detected by the first temperature detector is detected temperature A, and the temperature detected by the second temperature detector is detected temperature B, the end area in the axial direction is cooled by the cooling mechanism when detected temperature A>detected temperature B, and is not cooled by the cooling mechanism when detected temperature A≤detected temperature B, at the time of startup before any sheet is passed.

### SUMMARY

Aspects of non-limiting embodiments of the present disclosure relate to, in an image forming apparatus including a fixing device that applies heat and pressure, reducing a temperature difference, in the axial direction, between a passage area and a non-passage area of a pressing roller in the fixing device by adjusting a load applied to the pressing roller.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: an image forming unit that forms an unfixed image on a sheet; and a fixing device that fixes the unfixed image on the sheet, the fixing device including a fixing belt, multiple holding members that hold the fixing belt so as to allow the fixing belt to run, a pressing roller that presses the fixing belt from an outer circumferential surface side against one of the holding members to form a fixing processing part, a heater that heats the fixing belt, and a load adjustment mechanism that adjusts a load applied to the pressing roller and applies a fixing load to the pressing roller during a fixing operation, wherein at least at the end of the fixing operation of the fixing device, the load adjustment mechanism applies, as necessary, a low load that is lower than the fixing load to the pressing roller.

### BRIEF DESCRIPTION OF THE DRAWINGS

Exemplary embodiments of the present disclosure will be described in detail based on the following figures, wherein:

FIG. 1 schematically illustrates an image forming apparatus according to a first exemplary embodiment;

FIG. 2 schematically illustrates a fixing device provided in the image forming apparatus in FIG. 1;

FIG. 3A schematically illustrates a load adjustment mechanism and other components in the fixing device in FIG. 2, and FIG. 3B is a schematic side view of the load adjustment mechanism and other components in FIG. 3A;

FIGS. 4A and 4B are schematic side views showing states of a pressure roller and other components when a fixing operation is not performed and when the fixing operation is performed, respectively;

FIG. 5 is a table showing the relationship between the load level and the temperature difference in the pressure roller;

FIG. 6 is a flowchart showing a control operation for adjusting a load applied to the pressure roller;

FIG. 7 is a flowchart showing the remaining part of the control operation in FIG. 6;

FIGS. 8A to 8C are conceptual side views showing the states of the pressure roller, a fixing belt, and a contact member subjected to different levels of low load;

FIG. 9 is a table showing the relationship between the load level and the sheet transport width in a fixing device of an image forming apparatus according to a second exemplary embodiment;

FIG. 10 is a flowchart showing a control operation for adjusting a load applied to a pressure roller of the fixing device according to the second exemplary embodiment;

FIG. 11 is a flowchart showing the remaining part of the control operation in FIG. 10; and

FIG. 12A is a schematic side view showing a state when a fixing operation is performed on a sheet having a small transport width, and FIG. 12B is a graph showing an example axial temperature difference in the pressure roller occurring after the fixing operation in FIG. 12A.

### DETAILED DESCRIPTION

Exemplary embodiments of the present disclosure will be described with reference to the drawings.

### First Exemplary Embodiment

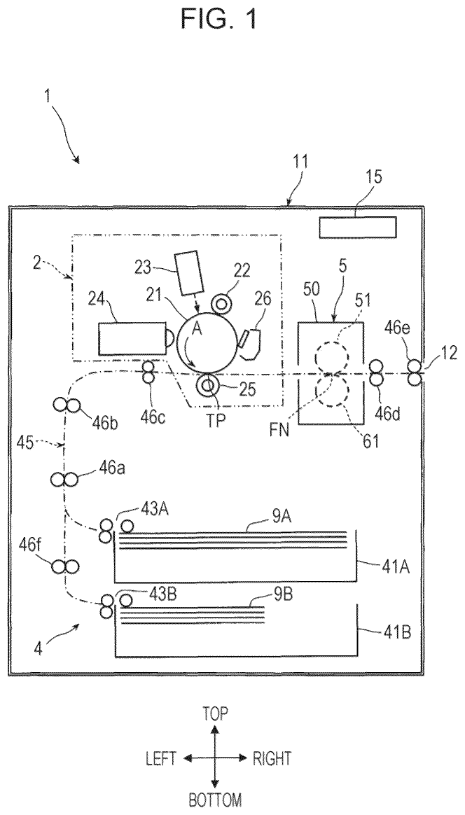

FIG. 1 shows an image forming apparatus 1 according to a first exemplary embodiment of the present disclosure.

In the specification and drawings, substantially the same components are denoted by the same reference signs. In the specification, such components will not be described repeatedly. In the drawings, for ease of understanding, illustration of parts other than those necessary for explaining is substantially omitted.

### 1. Configuration of Image Forming Apparatus

The image forming apparatus 1 forms an unfixed image corresponding to image information input from the outside on a sheet 9, which is an example of a recording medium.

As shown in FIG. 1, the image forming apparatus 1 has a housing 11. The image forming apparatus 1 includes, inside the housing 11, an image forming unit 2, a sheet feed device 4, a fixing device 5, and a control device 15.

A one-dot chain line in FIG. 1 indicates a transport path along which a sheet 9 is transported by a sheet transport device 45 in the housing 11.

The image forming unit 2 forms a toner image, composed of toner, serving as a developer, and transfers the toner image to a sheet 9.

The image forming unit 2 according to the first exemplary embodiment uses an electrophotographic system. The image forming unit 2 includes a photosensitive drum 21, a charging device 22, an exposure device 23, a developing device 24, a transfer device 25, and a cleaning device 26.

Among these, the photosensitive drum 21 is an example of an image carrier and is a drum-shaped photosensitive member having a photosensitive layer, serving as an image forming surface or an image carrying surface. The photosensitive drum 21 is powered by a driving device (not shown) and rotates in the arrow A direction.

The charging device 22 charges the outer circumferential surface (image forming surface) of the photosensitive drum 21 to a certain surface potential. The charging device 22 may include a charging member in a roller shape, for example, that is in contact with the image forming surface on the outer circumferential surface of the photosensitive drum 21 and that receives a charging current.

The exposure device 23 irradiates the charged outer circumferential surface of the photosensitive drum 21 with light corresponding to image information to form an electrostatic latent image. The exposure device 23 operates in response to an image signal generated by performing, in an image processing unit (not shown) or the like, predetermined processing on image information input from the outside. The image information is information related to an image, and examples thereof include characters, figures, photographs, and patterns.

The developing device 24 develops the electrostatic latent image formed on the outer circumferential surface of the photosensitive drum 21 with a developer (toner) of a corresponding predetermined color (for example, black) to form a visible toner image of the predetermined color. Examples of the developer include a two-component developer containing toner and carrier.

The transfer device 25 transfers the unfixed toner image formed on the outer circumferential surface of the photosensitive drum 21 to the sheet 9. The transfer device 25 include a transfer member in a roller shape, for example, that is in contact with the outer circumferential surface of the photosensitive drum 21 and that receives a transfer current.

A portion where the transfer device 25 and the photosensitive drum 21 are opposed to each other is a transfer position TP, where an unfixed toner image is transferred.

The cleaning device 26 removes unnecessary substances, such as unnecessary toner and paper dust attached to the outer circumferential surface of the photosensitive drum 21, to clean the outer circumferential surface of the photosensitive drum 21.

The sheet feed device 4 accommodates sheets 9 to be supplied to the transfer position TP in the image forming unit 2 and feeds the sheet 9 at predetermined timing.

The sheet feed device 4 includes containers 41 that accommodate the sheets 9, and feed-out devices 43 that feed out the sheets 9 one-by-one.

In the first exemplary embodiment, the containers 41 include two containers 41A and 41B, and the feed-out devices 43 include two feed-out devices 43A and 43B. The container 41A accommodates sheets 9A. The container 41B accommodates sheets 9B. The sheets 9A and 9B differ in size, for example.

The sheet 9 may be any sheet-like recording medium that is transported in the housing 11, and to which an unfixed toner image is transferred and fixed. As long as such conditions are satisfied, the material, form, and other characteristics of the recording medium is not particularly limited.

In the image forming apparatus 1, the sheet 9 may be a recording medium such as plain paper, coated paper, film, or thick paper cut into a predetermined size, or envelopes.

The sheet transport device 45 transports a sheet 9 to a necessary place in the housing 11.

The sheet transport device 45 includes a supply path, a relay path, and a discharge path. The supply path is a path along which the sheet 9 is transported from the sheet feed device 4 to the transfer position TP in the image forming unit 2. The relay path is a path along which the sheet 9 is transported from the transfer position TP in the image forming unit 2 to the fixing device 5. The discharge path is a path along which the sheet 9 is transported from the fixing device 5 to a discharge port 12 provided in a side surface or the like of the housing 11.

The sheet transport device 45 is formed by combining transport roller pairs 46, transport path members (not shown), and the like. The transport roller pairs 46 transport the sheet 9 by allowing the sheet 9 to pass therebetween. In the first exemplary embodiment, for example, six transport roller pairs 46a to 46e are used. The transport path members form a transport space and the like for the sheet 9 and guides the sheet 9 to the transport destination.

The fixing device 5 fixes an unfixed image to the sheet 9. The unfixed image is a toner image formed and transferred in the image forming unit 2.

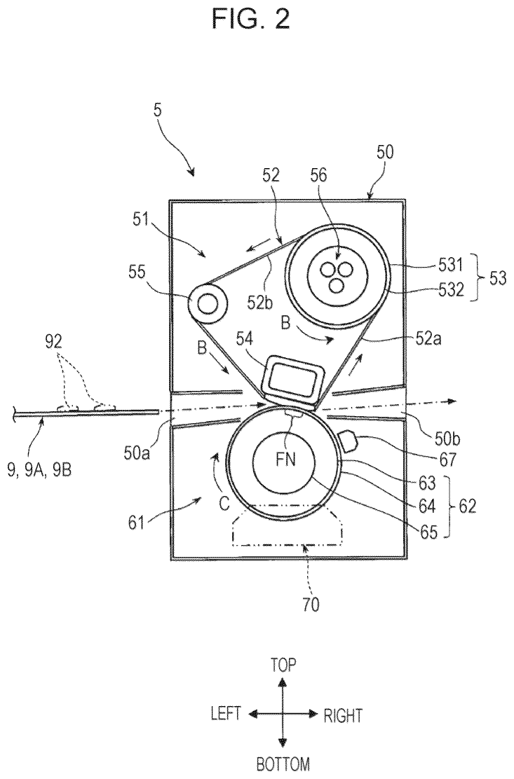

As shown in FIGS. 1 and 2, the fixing device 5 according to the first exemplary embodiment includes a heating rotary member 51 and a pressure rotary member 61 disposed inside a housing 50.

The housing 50 has an inlet 50a, through which the sheet 9 is introduced, and an outlet 50b, through which the sheet 9 after fixing is discharged.

In the fixing device 5, the heating rotary member 51 and the pressure rotary member 61 are arranged so as to be in contact with each other while rotating, and the contact part therebetween serves as a fixing processing part FN. The fixing processing part FN, also called a fixing nip, is a part where fixing processing is performed, in which heat and pressure are applied to the sheet 9 and the toner image passing therethrough.

The fixing device 5 will be described in detail below.

The control device 15 controls the overall operation of the image forming apparatus 1.

The control device 15 is a control circuit including an arithmetic processing unit, a storage element, and an input/output device. The control device 15 includes a storage device, as necessary.

The control device 15 is connected to various detectors, an operation panel, a communication unit, and the like (not shown), and thus receives necessary information. The control device 15 is also connected to various control circuits and the like to be controlled, and thus outputs necessary control information.

The control device 15 operates in accordance with a control program stored in the storage element or the like, while using control data, detection data, and the like.

### 2. Operation of Image Forming Apparatus

The image forming apparatus 1 basically forms an image as follows.

In the image forming apparatus 1, when a controller (not shown) receives a command for an image forming operation, the image forming unit 2 performs charging, exposing, developing, and transfer operations. In the image forming apparatus 1, the sheet feed device 4 and the sheet transport device 45 perform a sheet feed operation.

Thus, in the image forming unit 2, a toner image corresponding to the image information is formed on the image forming surface of the photosensitive drum 21 rotating in the arrow A direction. Meanwhile, in the sheet feed device 4, a sheet 9 (9A, 9B) is fed out, passes through the feed path of the sheet transport device 45, and is supplied to the transfer position TP in the image forming unit 2.

In the image forming unit 2, the toner image is transferred from the photosensitive drum 21 to the sheet 9 (9A, 9B) at the transfer position TP.

In the image forming unit 2, the cleaning device 26 performs a cleaning operation in accordance with the rotation of the photosensitive drum 21.

Thus, the image forming surface of the photosensitive drum 21 is cleaned by the cleaning device 26 at a timing including the time after the toner image has been transferred.

Subsequently, in the image forming apparatus 1, the sheet 9 to which the toner image has been transferred is transported to the fixing device 5 via the relay path of the sheet transport device 45. In the relay path, the sheet 9 nipped between the rotating photosensitive drum 21 and the transfer device 25 is fed out.

As shown in FIG. 2, in the fixing device 5, a fixing operation is performed, in which the sheet 9 (9A, 9B) to which a toner image 92 has been transferred is subjected to a fixing process in the fixing processing part FN.

As a result, in the fixing device 5, the unfixed toner image 92 on the sheet 9 is introduced into the fixing processing part FN, is subjected to pressure and heat while passing therethrough, and is fixed to the sheet 9.

Subsequently, in the image forming apparatus 1, the sheet 9 having gone through the fixing operation is discharged from the housing 50 of the fixing device 5 and transported to the discharge port 12 via the discharge path of the sheet transport device 45.

Then, the sheet 9 is discharged by the transport rollers 46e onto an output-sheet storage part (not shown) provided on a part of the housing 11 and is stored thereon.

Through these operations, a basic image forming operation, in which a monochrome image is formed on one side of a sheet 9, is completed.

### (3-1) Configuration of Fixing Device

Next, the fixing device 5 will be described in detail.

As shown in FIG. 2, the fixing device 5 uses a belt-nip heating unit as the heating rotary member 51. Furthermore, the fixing device 5 uses a pressure roller 62, which is an example of a pressing roller, as the pressure rotary member 61.

The heating rotary member 51 includes a fixing belt 52, three holding members 53, 54, and 55 holding the fixing belt 52 so as to allow the fixing belt 52 to run, and a heater 56 for heating the fixing belt 52.

The three holding members are a heating roller 53, a contact member 54, and a meandering correction roller 55. The fixing belt 52 is held so as to run in the arrow B direction (counterclockwise in FIG. 2).

The fixing belt 52 is an endless belt whose outer circumferential surface 52a is brought into contact with the surface of the sheet 9 to which the toner image 92 has been transferred, at the fixing processing part FN to perform the fixing processing.

The fixing belt 52 is an endless flexible belt having thermal conductivity and heat resistance. The fixing belt 52 may be a laminated belt formed by stacking an elastic layer and a release layer in this order on the outer circumferential surface of a cylindrical belt base.

The belt base is a cylindrical member made of synthetic resin, such as polyimide or polyamide. The elastic layer is made of an elastic material such as silicone rubber. The release layer is made of resin such as polytetrafluoroethylene.

The heating roller 53 is a rotary member that is heated by the heater 56 and heats the fixing belt 52.

The heating roller 53 includes a cylindrical roller base 531 and a surface layer 532 formed on the outer circumferential surface of the roller base 531.

The roller base 531 is a cylinder made of metal, such as aluminum. The roller base 531 is rotatably attached to a part of the housing 50 via a bearing (not shown). The surface layer 532 is an electrically non-conductive and thermally highly conductive layer.

Examples of the heater 56 include electric heating lamps arranged inside the roller base 531.

The contact member 54 is in contact with a certain position of an inner circumferential surface 52b of the fixing belt 52 to hold the fixing belt 52.

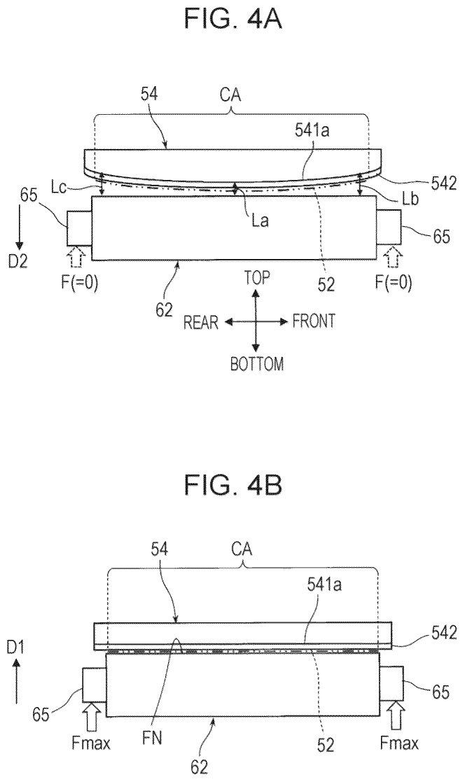

As shown in FIGS. 4A and 4B, etc., the contact member 54 is a structure including a tubular support 541 and a pad 542 provided on the lower surface of the support 541.

The support 541 is made of metal, such as aluminum. The support 541 is fixed to a part of the housing 50. The pad 542 has heat resistance and elasticity.

The contact member 54 includes a sliding sheet (not shown) disposed between the outer surface of the pad 542 and the inner circumferential surface 52b of the fixing belt 52. The sliding sheet is attached to the support 541 at one end thereof.

Furthermore, the contact member 54 is disposed so as to be slightly inclined backward as a whole, that is, a corner thereof on the side (left side in FIG. 2) from which the sheet 9 to be subjected to the fixing operation is introduced is lifted.

The meandering correction roller 55 corrects meandering of the fixing belt 52. Examples of the meandering correction roller 55 include a steering roller that corrects meandering of the fixing belt 52 by temporarily tilting and then returning a rotation shaft when the fixing belt 52 meanders.

The pressure roller 62, serving as the pressure rotary member 61, presses the fixing belt 52 against the contact member 54 from the outer circumferential surface 52a of the fixing belt 52 to form the fixing processing part FN.

As shown in FIG. 2, the pressure roller 62 includes a columnar or cylindrical roller base 63 and an elastic release layer 64 provided on the outer circumferential surface of the roller base 63. In FIG. 2 and other figures, reference sign 65 denotes shafts provided at both ends of the roller base 63.

At the time of, for example, the fixing operation, the pressure roller 62 is powered by a driving device (not shown) and is rotationally driven in the arrow C direction.

Thus, in the fixing device 5, as a result of the pressure roller 62 rotating in the arrow C direction, the fixing belt 52 is rotated in the arrow B direction.

Note that, in the fixing device 5, the heating roller 53 may be powered by a driving device (not shown) at predetermined timing to rotate in the arrow B direction. Examples of the predetermined timing include when the pressure roller 62 is separated from the fixing belt 52 and when the heating roller 53 is supposed to heat the fixing belt 52.

The pressure roller 62 has a load adjustment mechanism 70 that adjusts a load applied by the pressure roller 62 to the contact member 54 with the fixing belt 52 interposed therebetween to a predetermined value.

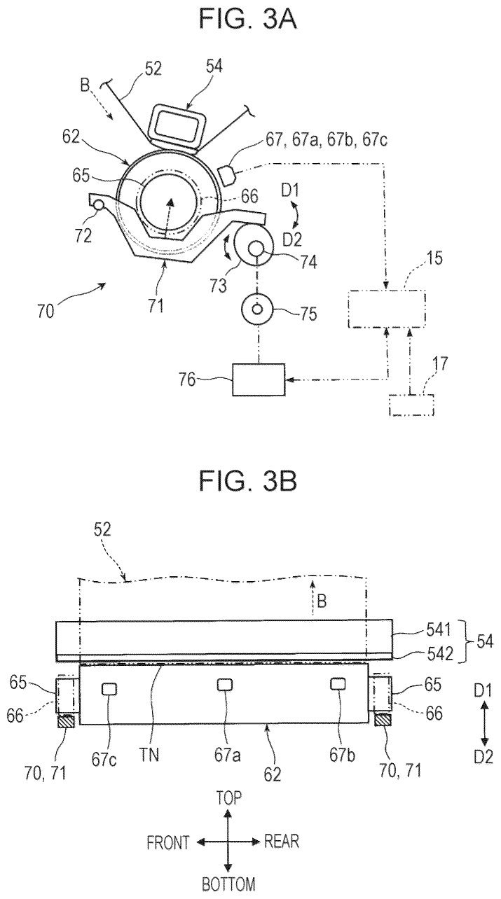

As shown in FIG. 3A, the load adjustment mechanism 70 includes a swing support frame 71, a cam 73, and a driving device 75.

The swing support frame 71 is supported by a support shaft 72 at one end thereof and swings about the support shaft 72. The swing support frame 71 has a recess for holding the shaft 65 of the pressure roller 62. The shaft 65 of the pressure roller 62 is supported in the recess in the swing support frame 71 with a bearing 66 therebetween.

The cam 73 is a plate cam that operates in a state of being fixed to the rotation shaft 74.

The cam 73 is in contact with the other end of the swing support frame 71 from below. The cam 73 is rotated by the rotation shaft 74, swinging the swing support frame 71 in directions D1 and D2, in which the swing support frame 71 moves toward and away from the contact member 54.

This operation of the cam 73 moves the pressure roller 62 toward and away from the contact member 54.

The driving device 75 rotates the rotation shaft 74 of the cam 73 by a predetermined angle. The driving device 75 includes a motor and a speed reduction mechanism.

The operation of the driving device 75 is controlled by a drive control device 76. The drive control device 76 controls the drive power supplied to the motor. The drive control device 76 is a controller in the control device 15 of the image forming apparatus 1, but may be a control circuit independent of the control device 15.

In a period in which an image forming operation and a consequent fixing operation are not performed, the swing support frame 71 of the load adjustment mechanism 70 is swung in the direction D2 away from the contact member 54, as shown in FIG. 4A. When a series of successive fixing operations is performed, periods between the respective fixing operations in the successive fixing operations are not included in the period in which the fixing operation is not performed.

At this time, the swing support frame 71 is swung by the operation of the cam 73. At this time, the cam 73 is rotated by a predetermined angle in a predetermined direction by the driving device 75 controlled and operated by the drive control device 76.

In this case, the load adjustment mechanism 70 separates the pressure roller 62 from the contact member 54 and the fixing belt 52. By doing so, the load adjustment mechanism 70 sets the load F applied to the shafts 65 of the pressure roller 62 to 0 (zero). At this time, the heat is not transmitted from the heated fixing belt 52 to the pressure roller 62.

In a period in which an image forming operation and a consequent fixing operation are performed, the swing support frame 71 of the load adjustment mechanism 70 is swung in the direction D1 toward the contact member 54 by the operation of the cam 73, as shown in FIG. 4B.

Also at this time, the swing support frame 71 is swung by the operation of the cam 73. Furthermore, the cam 73 at this time is also rotated by a predetermined angle in a predetermined direction by the driving device 75 controlled and operated by the drive control device 76.

In this case, the load adjustment mechanism 70 brings the pressure roller 62 into contact with the contact member 54 with the fixing belt 52 therebetween. By doing so, the load adjustment mechanism 70 sets the load F applied to the shafts 65 of the pressure roller 62 to the maximum load Fmax. The maximum load Fmax at this time is a fixing load, which is a minimum required load for the fixing operation.

### (3-2) Generation of Temperature Difference in Pressure Roller

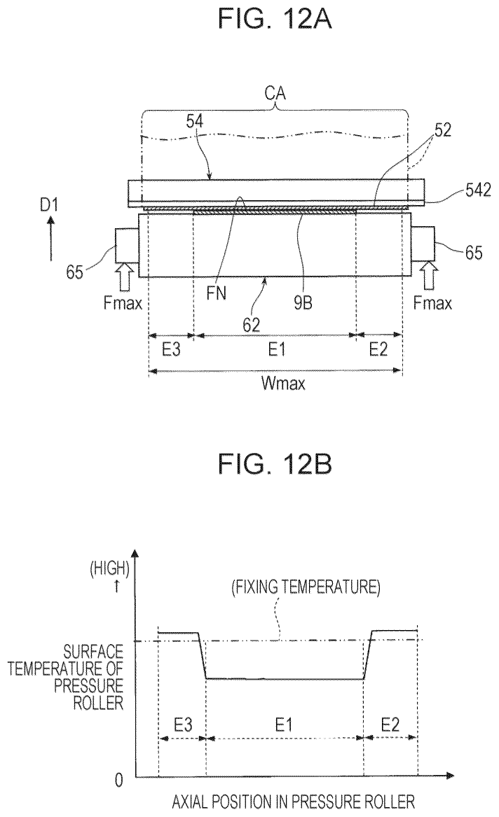

As shown in FIG. 12A, in the fixing device 5, when a fixing operation is performed on a sheet 9 having a transport width W that is smaller than the maximum transport width Wmax (maximum width) used in the image forming apparatus 1, a temperature difference as below occurs in the pressure roller 62.

Herein, the transport width W is the dimension of a sheet 9 in the direction orthogonal to the transport direction when the sheet 9 is transported in the image forming apparatus 1 (during transport). The sheet 9 having the small transport width W is assumed to be a sheet 9B. Furthermore, the sheet 9 is transported by a so-called center registration method, in which the sheet 9 is guided and transported such that the center position of the transport width W thereof passes through the center position of the transport path or the fixing processing part FN.

Specifically, when a fixing operation is performed on the sheet 9 having the transport width W, in the pressure roller 62, the surface temperature of a passage area E1, through which the sheet 9B passes while being in contact therewith, temporarily drops below the fixing temperature because the sheet 9B absorbs heat. Meanwhile, in the pressure roller 62, the surface temperatures of non-passage areas E2 and E3, through which the sheet 9B does not pass, exceed the fixing temperature because the areas E2 and E3 are kept heated without the heat thereof being absorbed by the sheet 9B.

As a result, as shown in FIG. 12B, in the pressure roller 62, a temperature difference occurs in the axial direction. This temperature difference tends to increase substantially in proportion to the number of times the fixing operation is successively performed on the sheets 9B.

The fixing temperature is a minimum required temperature in the fixing processing part FN during a fixing operation. In FIG. 12A, a portion in the contact member 54 with which the fixing belt 52 is in contact is denoted by reference sign CA. The total width of the passage area E1 and the non-passage areas E2 and E3 corresponds to the maximum transport width Wmax of the sheet 9. The width of the passage area E1 corresponds to the transport width W of the sheet 9B.

A temperature difference occurring in the pressure roller 62 causes the following problem.

That is, when a fixing operation on a sheet 9A having a larger transport width W than the sheet 9B is performed after the fixing operation on the sheet 9B ends, the sheet 9A may have fixing unevenness or wrinkles due to the temperature difference.

### (3-3) Countermeasure for Temperature Difference in Pressure Roller

To counter this problem, the fixing device 5 is configured such that the load adjustment mechanism 70 applies a low load lower than the fixing load (Fmax) to the pressure roller 62 as necessary, at least when a fixing operation is finished.

As shown in FIGS. 3A and 3B, in the fixing device 5, temperature sensors 67, which are an example of a temperature detector, that detect the temperatures of the central part and the ends of the pressure roller 62 in the axial direction are provided.

The temperature sensors 67 include a first temperature sensor 67a for detecting the temperature of the central part, a second temperature sensor 67b for detecting the temperature of the rear end, and a third temperature sensor 67c for detecting the temperature of the front end. The first, second, and third temperature sensors 67a, 67b, and 67c are connected to the control device 15 to input detected information to the control device 15.

The central part of the pressure roller 62 is a part through which the center of the sheet 9 in the width direction substantially passes, in the contact area of the pressure roller 62 with which a sheet 9 having the maximum transport width Wmax comes into contact. The ends of the pressure roller 62 are parts through which ends of the sheet 9 pass, in the contact area of the pressure roller 62 with which a sheet 9 having the maximum transport width Wmax comes into contact, or parts located inward by a certain distance from the aforementioned parts.

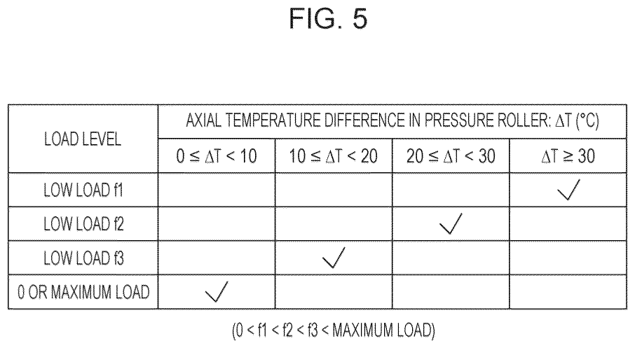

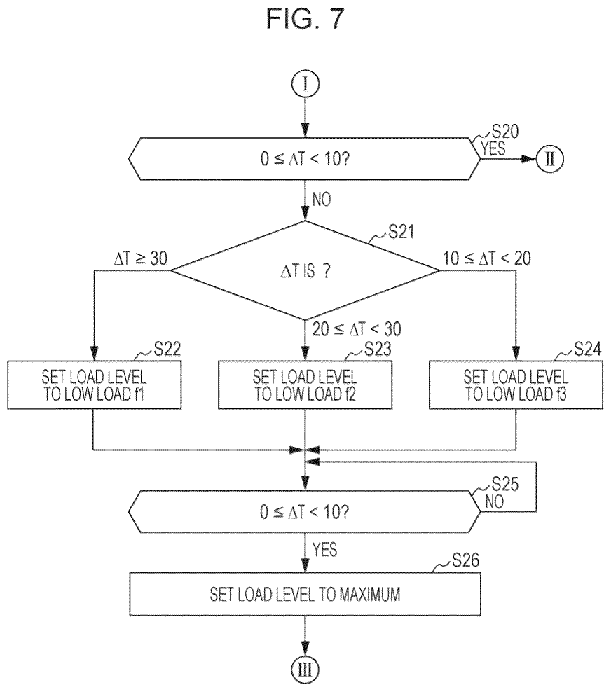

As shown in FIGS. 5 and 7, in the fixing device 5, the operation of applying a low load is performed when a temperature difference ΔT between the central part and the ends in the axial direction of the pressure roller 62 reaches or exceeds a predetermined value, using the information of the temperatures detected by the temperature sensors 67.

In other words, the fixing device 5 performs the operation of applying a low load only when necessary, that is, when the temperature difference ΔT reaches the predetermined temperature, and does not perform the operation when the temperature difference ΔT does not reach the predetermined temperature.

The temperature difference ΔT is a mean value obtained by averaging: a first temperature difference obtained by subtracting the temperature detected by the first temperature sensor 67a from the temperature detected by the second temperature sensor 67b; and a second temperature difference obtained by subtracting the temperature detected by the first temperature sensor 67a from the temperature detected by the third temperature sensor 67c.

Alternatively, the temperature difference ΔT may be selected from the first temperature difference and the second temperature difference, whichever is higher, or may be fixed to one of the first temperature difference and the second temperature difference.

In the fixing device 5, as shown in FIG. 5, the low load is divided into multiple levels, and the temperature difference ΔT is divided into multiple ranges.

In the first exemplary embodiment, as shown in FIG. 5, the low load is divided into three levels (low loads f1 to f3), and the temperature difference ΔT is divided into four numerical ranges. The relationship between the loads is: 0<f1<f2<f3<maximum load.

In this case, as shown in FIGS. 5 and 7, the fixing device 5 is configured to apply one of multiple levels of low loads corresponding to the temperature difference.

Furthermore, as shown in FIG. 4A, in the fixing device 5, the contact member 54 is bent such that the central part of the part CA, which is in contact with the fixing belt 52, is closer to the pressure roller 62 than the ends of the part CA are. The contact member 54 is in this shape when the pressure roller 62 under the maximum load is not in contact with the contact member 54 with the fixing belt 52 therebetween.

In the contact member 54 according to the first exemplary embodiment, a lower surface 541a of the tubular support body 541 is bent as described above. In FIG. 4A, for ease of understanding, the degree of bending of the lower surface 541a of the support body 541 is exaggerated.

In FIG. 4A, the clearance between the pressure roller 62 and the central part of the part CA of the lower surface 541a of the support body 541 in contact with the fixing belt 52 is denoted by reference sign La. The clearances between the pressure roller 62 and the front end and the rear end of the part CA of the lower surface 541a of the support member 541 in contact with the fixing belt 52 are denoted by reference signs Lb and Lc, respectively.

The relationship between the clearances La, Lb, and Lc is: La<Lb≈Lc.

As shown in FIG. 4B, the lower surface 541a of the support member 541, which has a bent shape, is made substantially flat during the fixing operation.

At this time, the pressure roller 62 under the maximum load is in contact with the lower surface 541a of the support body 541 with the fixing belt 52 therebetween. As a result, the pressure roller 62 presses the lower surface 541a of the support 541, temporarily eliminating the bending of the lower surface 541a and making the lower surface 541a substantially flat.

### (3-4) Operation of Load Adjustment Mechanism of Pressure Roller

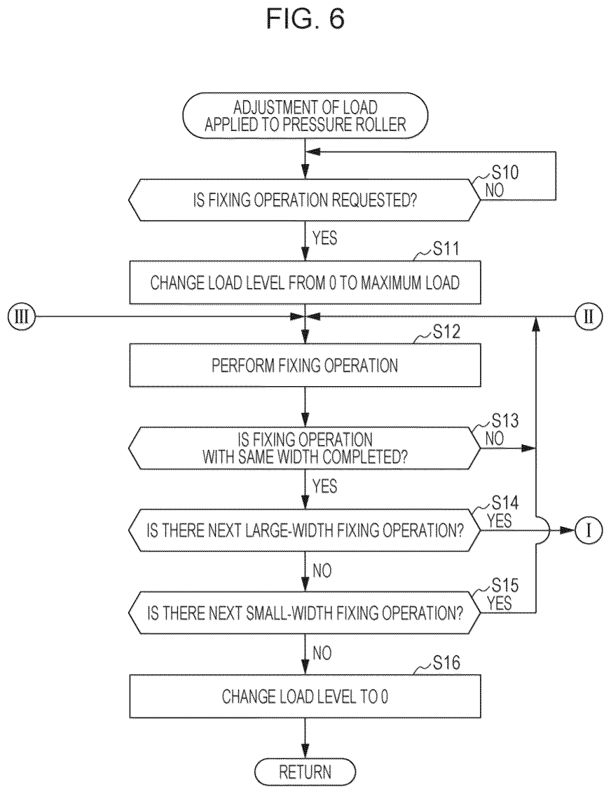

As shown in FIGS. 6 and 7, in the fixing device 5, the load adjustment mechanism 70 operates to adjust the load for the pressure roller 62.

In the fixing device 5, it is determined whether the control device 15 has received a request (command) for a fixing operation (step S10). The request for a fixing operation is included in a request for an image forming operation received by the image forming apparatus 1.

Because the fixing device 5 while awaiting a request for a fixing operation does not perform a fixing operation, the load F applied to the shafts 65 of the pressure roller 62 by the load adjustment mechanism 70 is set to 0 (see FIG. 4A).

An example of a time when the load F is set to 0 is a time when the image forming apparatus 1 is awaiting a request for a first image forming operation after the image forming apparatus 1 is turned on. Another example of a time when the load F is set to 0 is a time when a predetermined time has elapsed after an image forming operation has been finished and the image forming apparatus 1 is awaiting a request for a next image forming operation.

When a request for a fixing operation is received, the load F applied to the shafts 65 of the pressure roller 62 is changed from 0 to the maximum load Fmax (S11).

At this time, in the fixing device 5, the control device 15 controls and operates the load adjustment mechanism 70 to change the load F to the maximum load Fmax. The states of the load adjustment mechanism 70 and the pressure roller 62 at this time have been described above with reference to FIG. 4B.

This way, in the fixing device 5, the pressure roller 62 applies the minimum required load for a fixing operation to the fixing processing part FN.

Thereafter, the fixing device 5 performs the fixing operation in accordance with the image forming operation performed by the image forming apparatus 1 (S12).

The fixing operation at this time is performed in accordance with the conditions of the image forming operation. Examples of the conditions of the image forming operation include the size, including the transport width, of the sheet 9 used and the number of times the image forming operation is to be performed.

Furthermore, at this time, in the fixing device 5, it is determined whether the fixing operation on the sheet 9 having the same transport width W ends (S13).

Hence, in the fixing device 5, the fixing operation is continued until the fixing operation under the same condition ends.

When the fixing operation on the sheet 9 having the same transport width W ends, the control device 15 determines whether there is a next large-width fixing operation (S14).

The next large-width fixing operation is a fixing operation to be performed on a sheet 9A having a larger transport width W than the sheet 9B used in the preceding fixing operation.

If it is determined in step S14 that there is no next large-width fixing operation, then it is determined whether there is a next small-width fixing operation (S15).

The next small-width fixing operation is a fixing operation to be performed on a sheet 9 having a smaller transport width W than the sheet 9B used in the preceding fixing operation.

If it is determined in step S15 that there is a next small-width fixing operation, the next fixing operation is performed (S12).

In this case, because the transport width W of the sheet 9 is smaller than that of the preceding sheet, it is considered that there is no risk of the temperature difference ΔT in the pressure roller 62 causing fixing unevenness or other problems. Therefore, at this time, the load F applied by the load adjustment mechanism 70 in the next fixing operation is the same, i.e., the maximum load Fmax, as that in the preceding fixing operation.

If it is determined in step S14 that there is no next large-width fixing operation, as shown in FIG. 6, the load F applied to the shafts 65 of the pressure roller 62 is changed from the maximum load Fmax to 0 (S16).

At this time, in the fixing device 5, the control device 15 controls and operates the load adjustment mechanism 70 to change the load F from the maximum load Fmax to 0. The states of the load adjustment mechanism 70 and the pressure roller 62 at this time have been described above with reference to FIG. 4A.

In this case, the control device 15 determines again whether there is a request for a next new fixing operation (S10).

Meanwhile, if it is determined in step S14 that there is a next large-width fixing operation, the control device 15 determines whether the temperature difference ΔT (° C.) in the pressure roller 62 is in the range of 0≤ΔT<10, as shown in FIG. 7 (S20).

If it is determined in step S20 that the temperature difference ΔT in the pressure roller 62 is in the range of 0≤ΔT<10, the next large-width fixing operation is performed (S12).

In this case, because the temperature difference ΔT in the pressure roller 62 is relatively small, it is considered that there is no risk of the temperature difference ΔT causing problems such as fixing unevenness in the next large-width fixing operation. Therefore, the load F applied by the load adjustment mechanism 70 in the next large-width fixing operation is the same, i.e., the maximum load Fmax, as that in the preceding fixing operation.

The selection of the load at this time corresponds to the case where the “maximum load” among the load levels shown in FIG. 5 is selected.

Next, if it is determined in step S20 that the temperature difference ΔT in the pressure roller 62 is not in the range of 0≤ΔT<10, the control device 15 determines in what temperature range the temperature difference ΔT is (S21).

If it is determined in step S21 that the temperature difference ΔT is in the range of ΔT≥30, the level of the load F applied by the load adjustment mechanism 70 is set to the low load f1 (S22).

At this time, in the fixing device 5, the control device 15 controls and operates the load adjustment mechanism 70 to change the load F from the maximum load Fmax to the low load f1, which is the lowest low load.

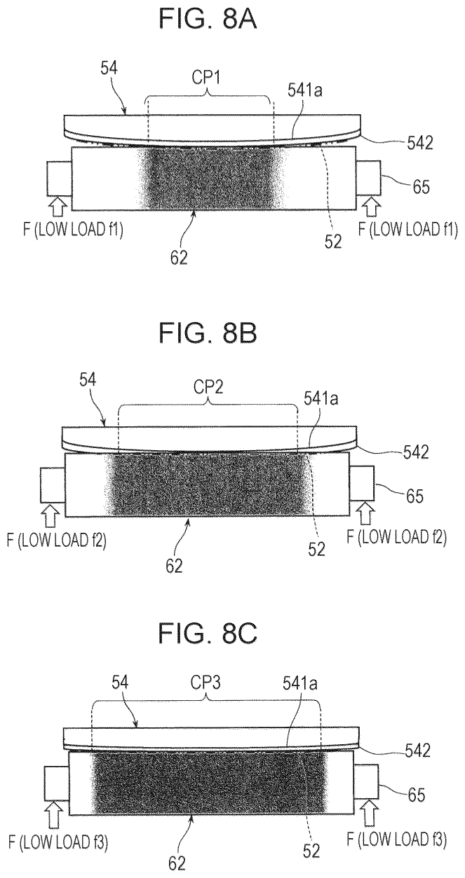

At this time, as shown in FIG. 8A, the load adjustment mechanism 70 operates such that the degree of contact between the pressure roller 62 and the contact member 54/the fixing belt 52 is relatively the lowest. Specifically, the load adjustment mechanism 70 moves the pressure roller 62 in a direction most far away from the contact member 54 so as to leave a small contact area between the pressure roller 62 and the fixing belt 52.

In FIG. 8A, reference sign CP1 denotes a part (contact part) where the pressure roller 62 receiving the low load f1 is in contact with the contact member 54 and the fixing belt 52.

The contact part CP1 is limited to a central part of the pressure roller 62 in the axial direction and is the narrowest part in the first exemplary embodiment.

The contact part CP1 may have substantially the same width as the transport width W of the sheet 9B used in the preceding fixing operation or substantially the same width as the minimum transport width W of the sheet 9 used in the image forming apparatus 1.

With this configuration, at this time, the ends of the pressure roller 62 other than the contact part CP1 are substantially not in contact with the heated fixing belt 52, and thus, the heat of the fixing belt 52 is unlikely to be transmitted to the pressure roller 62. In other words, at this time, the ends of the pressure roller 62 other than the contact part CP1 are not, or are unlikely to be, heated by the heated fixing belt 52.

In contrast, at this time, the contact part CP1 of the pressure roller 62 is continuously heated by the heated fixing belt 52. The heated state of the pressure roller 62 at this time is illustrated with a shade in FIG. 8A.

As a result, at this time, while the surface temperature of the ends of the pressure roller 62 other than the part CP1 in contact with the fixing belt 52 and the like is prevented from increasing, the contact part CP1 is reheated to recover the temperature even when the surface temperature of the contact part CP1 drops. Thus, at this time, the axial temperature difference ΔT in the pressure roller 62 is small.

In this case, the control device 15 determines whether the temperature difference ΔT in the pressure roller 62 is in the range of 0≤ΔT<10 (S25). Specifically, the load F in the fixing device 5 is maintained at the low load f1 until the temperature difference ΔT in the pressure roller 62 decreases to a level that causes no problem.

If it is determined in step S25 that the temperature difference ΔT is in the range of 0≤ΔT<10 (YES), the next large-width fixing operation is performed (S12).

Until the determination result in step S25 becomes YES, the fixing device 5 does not start the next large-width fixing operation, and the fixing operation is temporarily interrupted. This temporary interruption of the fixing operation also occurs when the low loads f2 and f3 are applied.

Accordingly, at this time, in the fixing device 5, the axial temperature difference ΔT in the pressure roller 62 is reduced by adjusting the load applied to the pressure roller 62.

Next, if it is determined in step S21 that the temperature difference ΔT is in the range of 20≤ΔT<30, the level of the load F applied by the load adjustment mechanism 70 is set to the low load f2 (S23).

At this time, in the fixing device 5, the control device 15 controls and operates the load adjustment mechanism 70 to change the load F from the maximum load Fmax to the low load f2, which is the intermediate low load.

At this time, as shown in FIG. 8B, the load adjustment mechanism 70 operates such that the degree of contact between the pressure roller 62 and the contact member 54/the fixing belt 52 is relatively intermediate low. Specifically, the load adjustment mechanism 70 moves the pressure roller 62 in a direction away from the contact member 54 at an intermediate level so as to leave a larger contact area between the pressure roller 62 and the fixing belt 52 than in the case where the low load f1 is applied.

In FIG. 8B, reference sign CP2 denotes a part (contact part) where the pressure roller 62 receiving the low load f2 is in contact with the contact member 54 and the fixing belt 52.

The contact part CP2 is wider than the contact part CP1 produced when the low load f1 is applied, but is limited to the central part of the pressure roller 62 in the axial direction. This part is the intermediate narrow part in the first exemplary embodiment.

The contact part CP2 is at least wider than the contact part CP1.

With this configuration, at this time, the ends of the pressure roller 62 other than the contact part CP2 are substantially not in contact with the heated fixing belt 52, and thus, the heat of the fixing belt 52 is unlikely to be transmitted to the pressure roller 62. In other words, at this time, the ends of the pressure roller 62 other than the contact part CP2 are not, or are unlikely to be, heated by the heated fixing belt 52.

In contrast, at this time, the contact part CP2 of the pressure roller 62 is continuously heated by the heated fixing belt 52. The heated state of the pressure roller 62 at this time is illustrated in FIG. 8B with a shade, as in FIG. 8A.

As a result, at this time, while the surface temperature of the ends of the pressure roller 62 other than the part CP2 in contact with the fixing belt 52 and the like is prevented from increasing, the contact part CP2 recovers the temperature even when the surface temperature of the contact part CP2 drops. Thus, at this time, the axial temperature difference ΔT in the pressure roller 62 is small.

Also in this case, the control device 15 determines whether the temperature difference ΔT in the pressure roller 62 is in the range of 0≤ΔT<10 (S25).

If it is determined in step S25 that the temperature difference ΔT is in the range of 0≤ΔT<10 (YES), the next large-width fixing operation is performed (S12).

Accordingly, also at this time, in the fixing device 5, the axial temperature difference ΔT in the pressure roller 62 is reduced by adjusting the load applied to the pressure roller 62.

Next, if it is determined in step S21 that the temperature difference ΔT is in the range of 10≤ΔT<20, the level of the load F applied by the load adjustment mechanism 70 is set to the low load f3 (S24).

At this time, in the fixing device 5, the control device 15 controls and operates the load adjustment mechanism 70 to change the load F from the maximum load Fmax to the low load f3, which is relatively the highest low load.

At this time, as shown in FIG. 8C, the load adjustment mechanism 70 operates such that the degree of contact between the pressure roller 62 and the contact member 54/the fixing belt 52 is relatively the highest. Specifically, the load adjustment mechanism 70 moves the pressure roller 62 in a direction least far away from the contact member 54 so as to leave a larger contact area between the pressure roller 62 and the fixing belt 52 than in the case where the low load f2 is applied.

In FIG. 8C, reference sign CP3 denotes a part (contact part) where the pressure roller 62 receiving the low load f3 is in contact with the contact member 54 and the fixing belt 52.

The contact part CP3 is wider than the contact part CP2 produced when the low load f2 is applied, but is limited to the part excluding the ends of the pressure roller 62 in the axial direction. This part is the widest part in the first exemplary embodiment.

The contact part CP3 is at least wider than the part CP2.

With this configuration, at this time, the ends of the pressure roller 62 other than the contact part CP3 are substantially not in contact with the heated fixing belt 52, and thus, the heat of the fixing belt 52 is unlikely to be transmitted to the pressure roller 62. In other words, at this time, the ends of the pressure roller 62 other than the contact part CP3 are not, or are unlikely to be, heated by the heated fixing belt 52.

In contrast, at this time, the contact part CP3 of the pressure roller 62 is continuously heated by the heated fixing belt 52. The heated state of the pressure roller 62 at this time is illustrated in FIG. 8C with a shade, as in FIG. 8A.

As a result, at this time, while the surface temperature of the ends of the pressure roller 62 other than the part CP3 in contact with the fixing belt 52 and the like is prevented from increasing, the contact part CP3 recovers the temperature even when the surface temperature of the contact part CP3 drops. Thus, at this time, the axial temperature difference ΔT in the pressure roller 62 is small.

Also in this case, the control device 15 determines whether the temperature difference ΔT in the pressure roller 62 is in the range of 0≤ΔT<10 (S25).

If it is determined in step S25 that the temperature difference ΔT is in the range of 0≤ΔT<10 (YES), the next large-width fixing operation is performed (S12).

Accordingly, also at this time, in the fixing device 5, the axial temperature difference ΔT in the pressure roller 62 is reduced by adjusting the load applied to the pressure roller 62.

As described above, in the fixing device 5, even when there is an axial temperature difference ΔT in the pressure roller 62, the temperature difference ΔT is reduced. Thus, fixing unevenness or wrinkling of the sheet 9 due to the temperature difference ΔT is suppressed.

Furthermore, the image forming apparatus 1 including the fixing device 5 performs a satisfactory image forming operation free from fixing unevenness or wrinkling of the sheet 9 due to the temperature difference ΔT in the fixing device 5.

Furthermore, as shown in FIG. 4A, in the fixing device 5, the central part of the part CA, which is in contact with the fixing belt 52, of the contact member 54 is bent so as to be closer to the pressure roller 62 than the ends of the part CA are.

Hence, in the fixing device 5, compared with a case where the central part and the ends of the part CA, which is in contact with the fixing belt 52, of the contact member 54 are located at the same distance from the pressure roller 62, the area over which the pressure roller 62 and the fixing belt 52 are in contact with each other is easily adjusted. Accordingly, in the fixing device 5, the axial temperature difference ΔT in the pressure roller 62 is easily reduced by adjusting the load applied to the pressure roller 62.

Furthermore, the fixing device 5 is configured to perform the operation of applying a low load when the axial temperature difference ΔT in the pressure roller 62 reaches or exceeds a predetermined value, using the information of the temperatures detected by the temperature sensors 67.

Thus, according to the fixing device 5, the axial temperature difference ΔT in the pressure roller 62 is appropriately reduced by adjusting the load F applied to the pressure roller 62 when necessary in accordance with the actual state of the temperature difference ΔT.

In other words, when there is no risk of the temperature difference ΔT causing a problem, such as fixing unevenness, adjustment of the load F applied to the pressure roller 62 is unnecessary, and the process may proceed to the next large-width fixing operation early.

Furthermore, in the fixing device 5, the low load is divided into three levels, namely, the low loads f1, f2, and f3, and the temperature difference ΔT is divided into multiple ranges, as shown in FIG. 5.

Therefore, according to the fixing device 5, compared with a case where the low load is not divided into multiple levels and the temperature difference is not divided into multiple ranges, the temperature difference ΔT in the pressure roller 62 may be appropriately reduced by finely adjusting the load F applied to the pressure roller 62.

### Second Exemplary Embodiment

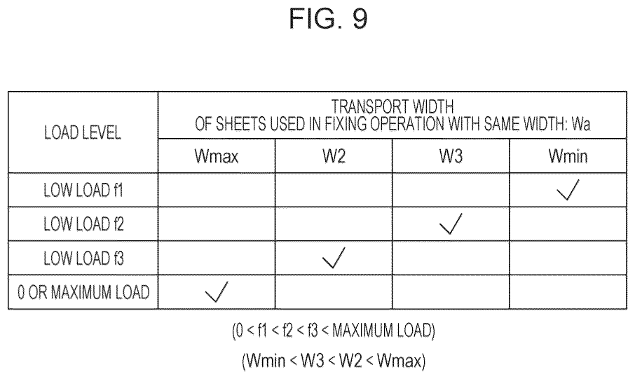

FIG. 9 is a table showing the relationship between the load level and the sheet transport width in a fixing device of an image forming apparatus according to a second exemplary embodiment.

The image forming apparatus and the fixing device used therein according to the second exemplary embodiment have the same configurations as those of the image forming apparatus 1 and the fixing device 5 used therein according to the first exemplary embodiment, except for the information used for the load adjustment by the load adjustment mechanism 70 of the fixing device.

The fixing device in the image forming apparatus according to the second exemplary embodiment includes a collector 17 (see FIG. 3A) that collects information on the transport width W of the sheet 9 and the number of successively used sheets 9.

The number of successively used sheets 9 is information corresponding to the number of times the image forming operation or the fixing operation using the sheets 9 having the same transport width W is successively requested.

Examples of the collector 17 include an operation panel through which information including the size of the sheet 9 used in the image forming operation and the number of times the image forming operation is performed (for example, the number of sheets to be printed) is selected or set.

Examples of the collector 17 also include a communication unit or the control device 15 that receives information including the size of the sheet 9 and the number of times the image forming operation is performed, which is selected or set on a setting screen of an external connection device connected to the image forming apparatus 1.

If a size detector for detecting the size of the sheets 9 accommodated in the accommodation body 41 of the sheet feed device 4 is provided, the collector 17 may be the size detector.

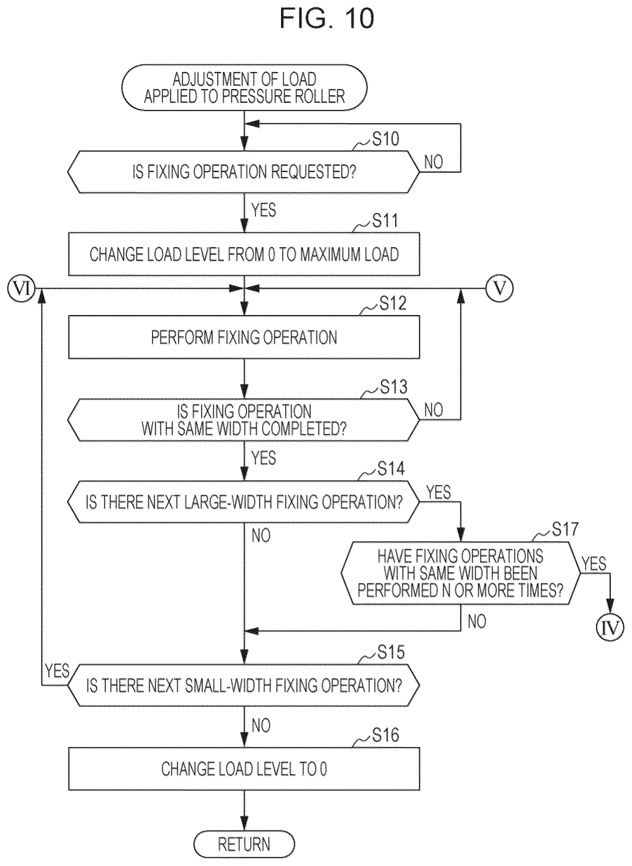

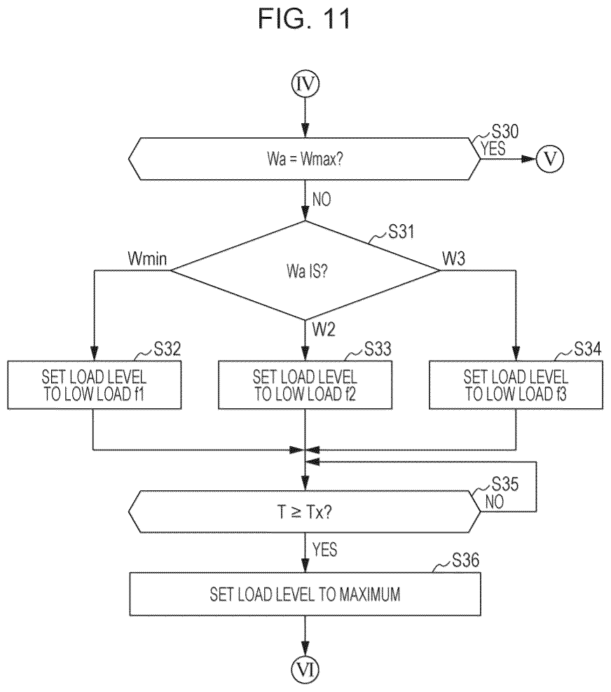

As shown in FIGS. 10 and 11, in the fixing device according to the second exemplary embodiment, the operation of applying a low load with the load adjustment mechanism 70 is performed when the number of successively used sheets 9, among the sheets 9, having the transport width W smaller than the maximum width Wmax during the transport satisfies a predetermined condition according to the information collected by the collector 17.

In the second exemplary embodiment, whether the number of successively used sheets satisfies the predetermined condition is determined by determining whether the number of times the fixing operation with the same width is performed is N or more, as shown in step S17 in FIG. 10.

In the fixing device according to the second exemplary embodiment, as shown in FIGS. 9 and 10, the low load is divided into three levels of low loads, f1 to f3, as in the first exemplary embodiment, and the predetermined condition is divided into multiple combinations of conditions.

As shown in FIG. 9, in the second exemplary embodiment, the transport width Wa of the sheets 9 used in the fixing operation with the same width is divided into three transport widths Wmin, W2, and W3, which are the transport widths W other than the maximum width Wmax. The three transport widths Wmin, W2, and W3 are all the transport widths of the sheets 9 used in the image forming apparatus. The relationship between the transport widths is: Wmin<W2<W3<Wmax.

In the second exemplary embodiment, as shown in step S30 in FIG. 11, it is determined whether the transport width Wa of the sheet 9 used in the fixing operation with the same width is the maximum width Wmax. Furthermore, in the second exemplary embodiment, as shown in FIGS. 9 and 11, it is determined which of the maximum width Wmax, the transport widths Wmin, W2, and W3 the transport width Wa of the sheet 9 used in the fixing operation with the same width is.

In this case, as shown in FIGS. 9 to 11, the fixing device determines the result when a combination of conditions is satisfied, the conditions including: the condition about the number of times the fixing operation with the same width is performed (corresponding to the number of times of successive use); and the condition of the transport width Wa of the sheet 9 used in the fixing operation with the same width.

Next, the fixing device in this case applies one of the low loads f1 to f3, which have different levels, according to the determination result.

As shown in FIGS. 10 and 11, in the fixing device according to the second exemplary embodiment, the load adjustment mechanism 70 operates to adjust the load for the pressure roller 62.

In this fixing device, the operation related to the adjustment of the load applied to the pressure roller 62, i.e., the operation from steps S10 to S16 in FIG. 10, is performed in the same manner as in the case of the fixing device 5 according to the first exemplary embodiment (see FIG. 6).

In particular, in this fixing device, if it is determined in step S14 that there is a next large-width fixing operation, it is determined whether the number of times the fixing operation with the same width is performed by step S13 is N or more (S17).

In this case, the number of times N may be set as appropriate from the standpoint of the necessity of changing the load F to be applied to the pressure roller 62 to a low load. The number of times N is set to, for example, three.

If it is determined in step S17 that the number of times the fixing operation with the same width is performed is less than N, the process proceeds to step S15 or S16, depending on the case, as shown in FIG. 10.

In this case, because the number of times the fixing operation with the same width is performed is less than N, which is a small number, it is considered that it is unnecessary to change the load F to be applied to the pressure roller 62 to a low load at this stage.

If it is determined in step S17 that the number of times the fixing operation with the same width is performed is greater than or equal to N, then, as shown in FIG. 11, it is determined whether the transport width Wa of the sheet 9 used in the preceding fixing operation with the same width is the maximum width Wmax (S30).

If it is determined in step S30 that the transport width Wa is the maximum width Wmax, it is considered that there is substantially no axial temperature difference ΔT in the pressure roller 62, and the next large-width fixing operation is performed (S12).

If it is determined in step S30 that the transport width Wa is not the maximum width Wmax (NO), then it is determined which one of the transport widths Wmin, W2, and W3 the transport width Wa is (S31).

If it is determined in step S31 that the transport width Wa is Wmin, it is considered that the temperature difference ΔT in the pressure roller 62 is the largest, and the load F applied by the load adjustment mechanism 70 is set to the low load f1 (S32).

At this time, in the fixing device according to the second exemplary embodiment, the control device 15 controls and operates the load adjustment mechanism 70 to change the load F from the maximum load Fmax to the low load f1, which is the lowest low load.

At this time, as shown in FIG. 8A, the load adjustment mechanism 70 operates such that the degree of contact between the pressure roller 62 and the contact member 54/the fixing belt 52 is relatively the lowest, as in the case where low load f1 is applied in the first exemplary embodiment.

As a result, as shown in FIG. 8A, in the pressure roller 62 of the fixing device according to the second exemplary embodiment, the surface temperature of the ends other than the part CP1, which is in contact with the fixing belt 52 and the like, is prevented from increasing. Meanwhile, in the pressure roller 62, even if the surface temperature of the contact part CP1 drops, the contact part CP1 is reheated to recover the temperature.

As a result, at this time, the axial temperature difference ΔT in the pressure roller 62 decreases.

Furthermore, in this case, the control device 15 determines whether the elapsed time T from when the load to be applied is changed to a low load has reached or exceeded a predetermined time Tx (S35).

The predetermined time Tx is an estimated time from when the low load is applied to when the axial temperature difference ΔT in the pressure roller 62 decreases to a level at which the temperature difference ΔT does not cause a problem such as fixing unevenness.

Alternatively, the predetermined time Tx may be set to a time, obtained in advance by experiment, taken for the temperature difference ΔT to decrease to a level at which such a problem does not occur.

The determination in step S35 may be the same as in the case of the fixing device 5 according to the first exemplary embodiment. Specifically, in step S35, it may be determined whether the temperature difference ΔT in the pressure roller 62 is in the range of 0≤ΔT<10 (see S25 in FIG. 7).

If it is determined in step S35 that the elapsed time T has reached or exceeded the predetermined time Tx (YES), the next large-width fixing operation is performed (S12).

Until the determination result in step S35 becomes YES, the fixing device according to the second exemplary embodiment does not start the next large-width fixing operation, and the fixing operation is temporarily interrupted. This temporary interruption of the fixing operation also occurs when the low loads f2 and f3 are applied.

Accordingly, at this time, in the fixing device according to the second exemplary embodiment, the axial temperature difference ΔT in the pressure roller 62 is reduced by adjusting the load applied to the pressure roller 62.

Next, if it is determined in step S31 that the transport width Wa is W2, it is considered that the temperature difference ΔT in the pressure roller 62 is an intermediate level, and the load F applied by the load adjustment mechanism 70 is set to the low load f2 (S33).

At this time, in the fixing device according to the second exemplary embodiment, the control device 15 controls and operates the load adjustment mechanism 70 to change the load F from the maximum load Fmax to the low load f2, which is the intermediate low load.

At this time, the load adjustment mechanism 70 operates such that the degree of contact between the pressure roller 62 and the contact member 54/the fixing belt 52 is relatively intermediate low, as in the case of the fixing device 5 according to the first exemplary embodiment. Specifically, the load adjustment mechanism 70 moves the pressure roller 62 in a direction away from the contact member 54 at an intermediate level so as to leave a larger contact area between the pressure roller 62 and the fixing belt 52 than in the case where the low load f1 is applied (see FIG. 8B).

As a result, in the pressure roller 62 of the fixing device according to the second exemplary embodiment, the surface temperature of the ends other than the part CP2, which is in contact with the fixing belt 52 and the like, is prevented from increasing. Meanwhile, in the pressure roller 62, even if the surface temperature of the contact part CP2 drops, the contact part CP2 is reheated to recover the temperature.

As a result, at this time, the axial temperature difference ΔT in the pressure roller 62 decreases.

Also in this case, in the fixing device according to the second exemplary embodiment, the control device 15 determines whether the elapsed time T has reached or exceeded the predetermined time Tx (S35).

If it is determined in step S35 that the elapsed time T has reached or exceeded the predetermined time Tx, the next large-width fixing operation is performed (S12).

Accordingly, also at this time, in the fixing device 5, the axial temperature difference ΔT in the pressure roller 62 is reduced by adjusting the load applied to the pressure roller 62.

Next, if it is determined in step S31 that the transport width Wa is W3, it is considered that the temperature difference ΔT in the pressure roller 62 is the smallest, and the load F applied by the load adjustment mechanism 70 is set to the low load f3 (S34).

At this time, in the fixing device according to the second exemplary embodiment, the control device 15 controls and operates the load adjustment mechanism 70 to change the load F from the maximum load Fmax to the low load f3, which is the highest low load.

At this time, the load adjustment mechanism 70 operates such that the degree of contact between the pressure roller 62 and the contact member 54/the fixing belt 52 is relatively high, as in the case of the fixing device 5 according to the first exemplary embodiment. Specifically, the load adjustment mechanism 70 moves the pressure roller 62 in a direction least far away from the contact member 54 so as to leave a larger contact area between the pressure roller 62 and the fixing belt 52 than in the case where the low load f2 is applied (see FIG. 8C).

As a result, as shown in FIG. 8C, in the pressure roller 62 of the fixing device according to the second exemplary embodiment, the surface temperature of the ends other than the part CP3, which is in contact with the fixing belt 52 and the like, is prevented from increasing. Meanwhile, in the pressure roller 62, even if the surface temperature of the contact part CP3 drops, the contact part CP3 is reheated to recover the temperature.

As a result, at this time, the axial temperature difference ΔT in the pressure roller 62 decreases.

Also in this case, in the fixing device according to the second exemplary embodiment, the control device 15 determines whether the elapsed time T has reached or exceeded the predetermined time Tx (S35).

If it is determined in step S35 that the elapsed time T has reached or exceeded the predetermined time Tx, the next large-width fixing operation is performed (S12).

Accordingly, also at this time, in the fixing device 5, the axial temperature difference ΔT in the pressure roller 62 is reduced by adjusting the load applied to the pressure roller 62.

As described above, in the fixing device according to the second exemplary embodiment, even when there is an axial temperature difference ΔT in the pressure roller 62, the temperature difference ΔT is reduced, and thus, fixing unevenness or wrinkling of the sheet 9 due to the temperature difference ΔT is suppressed.

Furthermore, the image forming apparatus 1 including the fixing device according to the second exemplary embodiment performs a satisfactory image forming operation free from fixing unevenness or wrinkling of the sheet 9 due to the temperature difference ΔT in the fixing device.

### First Modification

The present disclosure is not limited to the configuration examples described in the first and second exemplary embodiments, and modifications, such as necessary changes and combinations, may be made without departing from the spirit of the disclosure described in the claims. The present disclosure thus includes, for example, the following modifications.

In the first and second exemplary embodiments, there may be one level of low load and one value of the temperature difference ΔT in the pressure roller 62 when the low load is to be applied.

In the first and second exemplary embodiments, there may be two levels of low load and two values of the temperature difference ΔT in the pressure roller 62, serving as criteria for determining which level of low load is to be applied.

Furthermore, in the first and second exemplary embodiments, there may be three or more levels of low load and three or more values of the temperature difference ΔT in the pressure roller 62, serving as the criteria for determining which level of low load is to be applied.

In the second exemplary embodiment, whether to apply the low load and the level of the low load are adjusted and controlled according to the information on the difference in the transport width W of the sheet 9 used.

In the second exemplary embodiment, the adjustment and control may be performed according to the information on the difference in thickness of the sheet 9, for example.

In that case, the adjustment and control may be performed according to the information on the difference in the thickness of the sheet 9 and the information on the difference in the transport width W of the sheet 9 combined together. In this case, for example, because the axial temperature difference in the pressure roller 62 is more likely to occur with an increase in the thickness of the sheet 9, the adjustment and control may be performed in accordance with the increase in the thickness of the sheet 9.

In the first and second exemplary embodiments, the contact member 54 is fixed at a certain position to serve as a member for holding the fixing belt 52 and has such a shape that the central part of the part CA, which is in contact with the fixing belt 52, is located closer to the pressure roller 62 than the ends of the part CA are.

However, the holding member having such a shape may be a rotary member having such a shape (for example, a spindle shape or a crown shape).

In the fixing device 5, the type and method of the heater 56, and the type, number, etc., of holding members for holding the fixing belt 52, other than the heating roller 53, may be changed.

Although the image forming apparatus 1 forms a monochrome image in the first exemplary embodiment and the like, the image forming apparatus of the present disclosure may form a multicolor image formed by combining multiple color toners. The image forming method, transfer method, etc., of the image forming apparatus of the present disclosure are not particularly limited, as long as the image forming apparatus uses the fixing device as described in the first and second exemplary embodiments.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image forming apparatus comprising: an image forming unit that forms an unfixed image on a sheet; and a fixing device that fixes the unfixed image on the sheet, the fixing device including a fixing belt, multiple holding members that hold the fixing belt so as to allow the fixing belt to run, a pressing roller that presses the fixing belt from an outer circumferential surface side against one of the holding members to form a fixing processing part, a heater that heats the fixing belt, and a load adjustment mechanism that adjusts a load applied to the pressing roller and applies a fixing load to the pressing roller during a fixing operation, wherein, at least at the end of the fixing operation of the fixing device, the load adjustment mechanism applies, as necessary, a low load that is lower than the fixing load to the pressing roller.

(((2)))

The image forming apparatus according to (((1))), wherein the one holding member has such a shape that a central part of a part in contact with the fixing belt is closer to the pressing roller than ends of the part are.

(((3)))

The image forming apparatus according to (((2))), wherein the one holding member is a contact member that is disposed at a certain position so as to be in contact with an inner circumferential surface of the fixing belt.

(((4)))

The image forming apparatus according to any one of (((1))) to (((3))), further comprising temperature detectors that detect temperatures of a central part and ends of the pressing roller in an axial direction of the pressing roller, wherein the low load is applied when a temperature difference between the central part and the ends of the pressing roller in the axial direction reaches or exceeds a predetermined value, using information on the temperatures detected by the temperature detectors.

(((5)))

The image forming apparatus according to (((4))), wherein the low load is divided into multiple levels, the temperature difference is divided into multiple ranges, and one of multiple levels of low loads is applied according to the temperature difference.

(((6)))

The image forming apparatus according to any one of (((1)) to (((3))), further comprising a collector that collects information on at least the width of the sheet and the number of successively used sheets, wherein the low load is applied when the number of successively used sheets having a width smaller than a maximum width during transport, among the sheets, satisfies a predetermined condition, using the information collected by the collector.

(((7)))

The image forming apparatus according to (((6))), wherein the low load is divided into multiple levels, the predetermined condition is divided into multiple combinations of conditions, and one of multiple levels of low loads is applied according to the result when the combination of conditions is satisfied.

What is claimed is:

1. An image forming apparatus comprising:
an image forming unit that forms an unfixed image on a sheet; and
a fixing device that fixes the unfixed image on the sheet, the fixing device including a fixing belt, multiple holding members that hold the fixing belt so as to allow the fixing belt to run, a pressing roller that presses the fixing belt from an outer circumferential surface side against one of the holding members to form a fixing processing part, a heater that heats the fixing belt, and a load adjustment mechanism that adjusts a load applied to the pressing roller and applies a fixing load to the pressing roller during a fixing operation,
wherein, at least at the end of the fixing operation of the fixing device, the load adjustment mechanism applies, as necessary, a low load that is lower than the fixing load to the pressing roller.

2. The image forming apparatus according to claim 1, wherein the one holding member has such a shape that a central part of a part in contact with the fixing belt is closer to the pressing roller than ends of the part are.

3. The image forming apparatus according to claim 2, wherein the one holding member is a contact member that is disposed at a certain position so as to be in contact with an inner circumferential surface of the fixing belt.

4. The image forming apparatus according to claim 1, further comprising temperature detectors that detect temperatures of a central part and ends of the pressing roller in an axial direction of the pressing roller,
wherein the low load is applied when a temperature difference between the central part and the ends of the pressing roller in the axial direction reaches or exceeds a predetermined value, using information on the temperatures detected by the temperature detectors.

5. The image forming apparatus according to claim 4, wherein:
the low load is divided into multiple levels;
the temperature difference is divided into multiple ranges; and
one of multiple levels of low loads is applied according to the temperature difference.

6. The image forming apparatus according to claim 1, further comprising a collector that collects information on at least the width of the sheet and the number of successively used sheets,
wherein the low load is applied when the number of successively used sheets having a width smaller than a maximum width during transport, among the sheets, satisfies a predetermined condition, using the information collected by the collector.

7. The image forming apparatus according to claim 6, wherein:
the low load is divided into multiple levels;
the predetermined condition is divided into multiple combinations of conditions; and
one of multiple levels of low loads is applied according to the result when the combination of conditions is satisfied.

8. An image forming apparatus comprising:
image forming means for forming an unfixed image on a sheet; and
fixing means for fixing the unfixed image on the sheet, the fixing means including a fixing belt, multiple holding members that hold the fixing belt so as to allow the fixing belt to run, a pressing roller that presses the fixing belt from an outer circumferential surface side against one of the holding members to form a fixing processing part, a heater that heats the fixing belt, and a load adjustment mechanism that adjusts a load applied to the pressing roller and applies a fixing load to the pressing roller during a fixing operation,
wherein, at least at the end of the fixing operation of the fixing means, the load adjustment mechanism applies, as necessary, a low load that is lower than the fixing load to the pressing roller.
